(19) United States
(12) Patent Application Publication
(10) Pub. No.: US 2015/0193947 A1
(43) Pub. Date: Jul. 9, 2015

(54) SYSTEM AND METHOD TO GENERATE HIGH DYNAMIC RANGE IMAGES WITH REDUCED GHOSTING AND MOTION BLUR

(71) Applicant: QUALCOMM INCORPORATED, SAN DIEGO, CA (US)

(72) Inventors: Piyush Sharma, San Diego, CA (US); Chao Jia, Austin, TX (US); Ramin Rezaiifar, Del Mar, CA (US); Nitesh Shroff, San Diego, CA (US)

(73) Assignee: QUALCOMM INCORPORATED, SAN DIEGO, CA (US)

(21) Appl. No.: 14/265,768

(22) Filed: Apr. 30, 2014

Related U.S. Application Data
(60) Provisional application No. 61/924,039, filed on Jan. 6, 2014.

(51) Int. Cl. G06T 7/20; G06T 7/00

(52) U.S. Cl. CPC G06T 7/2033; G06T 7/0038; G06T 2207/20208; G06T 2207/20201

(57) ABSTRACT

Methods, devices, and computer program products for generating high dynamic range images with reduced ghosting and motion blur are disclosed herein. In some aspects, methods of detecting areas of motion blur in an image are disclosed. This detection may be based on either a row-based approach, or a patch-based approach. These approaches may be used to classify images or portions of images as being either blurry or sharp, based upon a threshold value. The threshold value may be determined empirically.

### RELATED APPLICATIONS

This application claims the benefit of U.S. Provisional Application No. 61/924,039, entitled “SYSTEM AND METHOD TO GENERATE HIGH DYNAMIC RANGE IMAGES WITH REDUCED GHOSTING AND MOTION BLUR,” filed Jan. 6, 2014, which is assigned to the assignee hereof and hereby expressly incorporated by reference herein.

### FIELD

The present application relates generally to digital imaging, and more specifically to systems, methods, and devices for generating high dynamic range images with reduced ghosting and motion blur.

### BACKGROUND

In some aspects, the use of high-dynamic range (HDR) images is desired. Such an HDR image may capture images with two or more different exposure lengths, using either the same physical pixels or different pixels. The capture of images with different exposure lengths may allow a final HDR image to show a greater range of colors depths than might be possible using a single exposure length. For example, such a technique may allow a shorter-exposure length to be used to brighter regions of the image, to show more detail in those areas. With a longer exposure length, the pixels in these brighter areas may otherwise reach their full capacity, and accordingly, detail may be lost. The technique may also use a longer-exposure length to show more detail in darker areas of the image. If a shorter-exposure length was used for these areas, less light may be gathered, and accordingly these images may appear darker, with less detail, and with a lower signal-to-noise ratio due to the low amount of light collected.

Because multiple images with different exposure lengths are used to construct such an HDR image, each of these exposures will be cover a different period of time. These periods of time may overlap with each other, or may be sequential or otherwise non-overlapping. Because of these temporal differences, objects in the images may be in different positions in each image. For example, if multiple images are captured of a moving automobile, the automobile will appear in different positions in the images. In a combined images, these varying positions may result in ghosting. Similarly, the moving automobile may also be blurry in certain images, due to its movement during the exposure time of the image. Further, other portions of the image may not be blurred, as those portions may not be moving during the capture of the image. Accordingly, it may be desired to capture quality HDR images without ghosting or blurriness due to moving objects.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous innovations of this invention include systems and methods of generating high dynamic range images with reduced ghosting and motion blur.

Accordingly, one aspect relates to a method of determining the blurriness of an image using row-based sampling. The method includes uniformly sampling two or more rows of the image, calculating a blurriness value for each of the sampled rows using a multi-scale Difference of Gaussian edge detection, and calculating an average blurriness value for an image, the average blurriness value based on an average of the blurriness values for each of the sampled rows. In some aspects, uniformly sampling two or more rows of the image includes uniformly sampling each of the rows of the image, or sampling every Nth row of the image, where N is an integer larger than one. In some aspects, uniformly sampling two or more rows of the image includes sampling N rows of the images, wherein the N rows are approximately evenly spaced out throughout the image. The average blurriness value for an image may be based on a weighted average of the average of the blurriness values for each of the sampled rows. The method may also include comparing the average blurriness value for the image to a threshold blurriness value. The threshold blurriness value may be based, at least in part, on a plurality of average blurriness values for a plurality of different images. The method may also include determining whether to keep or discard the image, based at least in part on the comparison to the threshold blurriness value.

Another aspect relates to a device configured to determine the blurriness of an image using row-based sampling. The device includes a processor configured to uniformly sample two or more rows of the image, calculate a blurriness value for each of the sampled rows using a multi-scale Difference of Gaussian edge detection, and calculate an average blurriness value for an image, the average blurriness value based on an average of the blurriness values for each of the sampled rows. The device may also include a processor configured to compare the average blurriness value for the image to a threshold blurriness value. This threshold blurriness value may be based, at least in part, on a plurality of average blurriness values for a plurality of different images. The processor may be further configured to determine whether to keep or discard the image, based at least in part on the comparison to the threshold blurriness value.

Another aspect relates to a device configured to determine the blurriness of an image using row-based sampling. The device includes means for uniformly sampling two or more rows of the image, means for calculating a blurriness value for each of the sampled rows using a multi-scale Difference of Gaussian edge detection, and means for calculating an average blurriness value for an image, the average blurriness value based on an average of the blurriness values for each of the sampled rows.

Another aspect relates to a non-transitory computer storage that stores executable program instructions that direct a device to perform a process. The process includes uniformly sampling two or more rows of the image, calculating a blurriness value for each of the sampled rows using a multi-scale Difference of Gaussian edge detection, and calculating an average blurriness value for an image, the average blurriness value based on an average of the blurriness values for each of the sampled rows.

One aspects relates to a method of determining the blurriness of an image using patch-based sampling. The method includes sampling two or more non-overlapping patches of the image, for each of the two or more non-overlapping patches, classifying each patch as either blurry or not blurry, and calculating a final blurriness value for the image, the final blurriness value based upon a calculation of the proportion of the patches which are either blurry or not blurry. In some aspects, each of the two or more non-overlapping patches of the image may be a same size. In some aspects, classifying each patch as either blurry or not blurry may include using a trained classifier to classify each patch. The final blurriness value above may be calculated while ignoring homogenous patches of the image, which may include determining if a patch is homogenous based at least in part on a comparison between an average of an absolute value of an image derivative for the patch and a homogeneity threshold. The method may also compare the average blurriness value for the image to a threshold blurriness value, which might be based, at least in part, on a plurality of average blurriness values for a plurality of different images. The method may also include determining whether to keep or discard the image, based at least in part on the comparison to the threshold blurriness value.

Another aspect relates to a device configured to determine the blurriness of an image using row-based sampling. The device includes a processor configured to sample two or more non-overlapping patches of the image, for each of the two or more non-overlapping patches, classify each patch as either blurry or not blurry, and calculate a final blurriness value for the image, the final blurriness value based upon a calculation of the proportion of the patches which are either blurry or not blurry.

One aspect relates to a device configured to determine the blurriness of an image using row-based sampling. The device includes means for sampling two or more non-overlapping patches of the image, means for classifying each patch as either blurry or not blurry for each of the two or more non-overlapping patches, and means for calculating a final blurriness value for the image, the final blurriness value based upon a calculation of the proportion of the patches which are either blurry or not blurry.

Another aspect relates to a non-transitory computer storage that stores executable program instructions that direct a device to perform a process. The process includes sampling two or more non-overlapping patches of the image, for each of the two or more non-overlapping patches, classifying each patch as either blurry or not blurry, and calculating a final blurriness value for the image, the final blurriness value based upon a calculation of the proportion of the patches which are either blurry or not blurry.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1A is a graph illustrating an example of the edges of a sharp image.

FIG. 1B is a graph illustrating an example of the edges of a blurry image.

FIG. 2A is a flowchart illustrating an example of a method for row-based detection of locally motion-blurred images.

FIG. 2B is a plot illustrating an example of a one dimensional difference-of-Gaussians at multiple scales.

FIG. 3 is flowchart illustrating an example of a method for patch-based motion blur detection.

FIG. 4 is an illustration of a method for patch-based classification to determine whether the patches are blurry or sharp.

FIG. 5 is an illustration of an unsupervised-feature learning auto-encoder used for patch-based region classification system.

FIG. 6 depicts a high-level block diagram of a device having a set of components including a processor operatively coupled to an image sensor.

### DETAILED DESCRIPTION

Object motion can create various potential issues in a high-dynamic range (HDR) image. Such an HDR image may use two or more exposure lengths, and capture one or more frame at each of the two or more exposure lengths. However, objects that are in motion may be captured in different locations in different images, which may lead to ghosting when the images are combined to form a single HDR image. Further, objects which are moving may also be blurred in any of the images, due to their motion during the exposure time of that image. This object motion may lead to a blurring of that particular object in the captured image, while the remainder of the image may be sharp. Accordingly, it may be desirable to use the sharp portion of the image to form an HDR image, but to not use the blurred portion of the image.

In some aspects, an earlier technique, which may be referred to as “Ghostbuster HDR,” may be used to diminish or remove the occurrences of ghosting in a combined HDR image. This technique is described in detail in U.S. patent application Ser. No. 14/012,534, which is incorporated by reference in its entirety herein. However, ghosting is only one of the problems that object motion may introduce into an HDR image. In addition to ghosting, object motion can also lead to that object being motion-blurred in a given image. If this motion-blurred object is used to form the final HDR image, the object may also be motion blurred in the final HDR image. Accordingly, in order to avoid this problem, it may be desirable to replace motion-blurred objects in certain frames with non-motion blurred objects from other frames. Alternatively, it may be desirable to only use the non-motion-blurred objects in a given frame in order to form the HDR image. In order to do this, it may be desired to detect locally motion-blurred portions or regions of references images. For example, a reference image may be one of the images that is captured in order to form an HDR image. In some implementations, and/or in some instances of a particular implementation, one or more particular images of a plurality of captured images may be chosen to be reference images. For example, these images may be chosen as reference images based on the order in which the images were captured (such as being in the center of a number of different images, temporally) or based on other factors such as how clear and sharp the image is generally. However, these images may contain locally motion-blurred portions, and it may be desired to determine which portion of the image, if any, is motion-blurred.

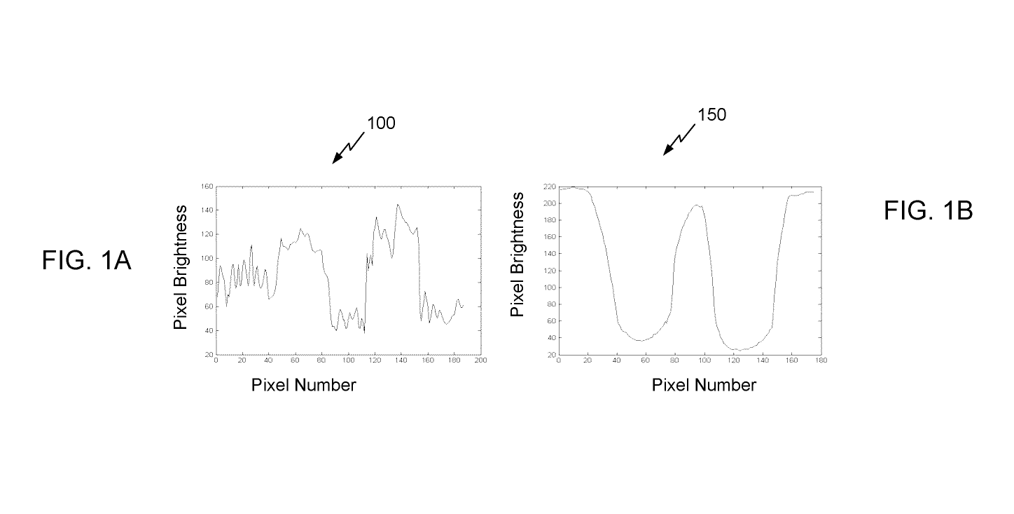

FIG. 1A is a graph illustrating an example of the edges of a sharp image. In illustration 100, the x-axis is a pixel number in a row/column of the image, such that each pixel is adjacent to the one beside it. In illustration 100, the y-axis is the luminance (brightness) of the particular pixel. Of note in illustration 100 is that each pixel's brightness can vary significantly from the adjacent pixels. This means that edges may be sharp, as a bright pixel may be next to a dark pixel for a sharp transition between colors and brightness. FIG. 1B is a graph illustrating an example of the edges of a blurry image. As in illustration 100, the x-axis is pixel numbers, while the y-axis is the luminance of a given pixel. As shown in illustration 150, the edges in a blurry image (FIG. 1B) are much wider than those in a sharp image (FIG. 1A). For example, changes in luminance in illustration 150 (indicative of an edge) are much more gradual than those in illustration 100. As illustrated, sharp images include sharp changes in color and luminance in nearby pixels. Similarly, sharp portions of an image include sharp changes in colors and luminance, while blurry portions of an image may include much more gradual changes in color and luminance in nearby pixels. Various methods may be used to detect motion-blurred regions in images. In some aspects, different methods of detecting motion-blurred regions in images may be used individually, or may be used together.

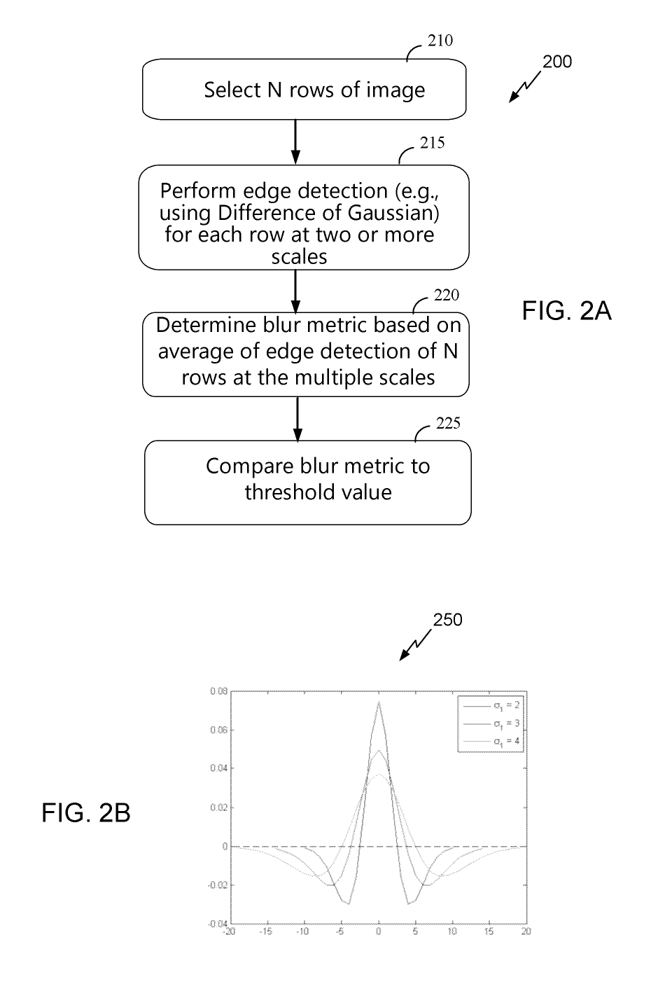

One method that may be used to detect motion-blurred regions of an image involves identifying certain rows to process in an image, processing the rows to determine edges, and then evaluating the edges found in the identified rows together to determine a metric that is used to determine if the image includes one or more motion blurred regions. FIG. 2A is an illustration 200 of a method for row-based detection of locally motion-blurred images. This method looks for horizontal motion of the objects (e.g., moving people or cars) by extracting and then evaluating multiple rows from the image that is being analyzed.

At block 210 in FIG. 2A, the method may select (or sample) N rows of the image. “Sampling” when used herein is a broad term that refers to selecting a row of an image including all of the image pixel data that is included in the selected row, to perform additional processing on the pixel data for example, as illustrated in FIG. 2A. For example, a number of rows may be uniformly selected from the image, such as by extracting a certain number of rows, evenly space in the image, or by selecting a particular proportion of the rows, such as every row, every second row, every fourth row, and so on. In some embodiments the rows may be selected in a non-uniform manner, for example, if there is a particular portion of an image (or images) that have been identified or determined to more closely evaluate for motion-blurred regions. Accordingly, in some embodiments the rows that will be processed to determine the differences of Gaussian are uniformly selected, but in other embodiments rows that will be processed to determine the differences of Gaussian may be non-uniformly selected. In some embodiments, N may be a predefined number of rows, such as 5, 10, 20, or 50 rows, or N may be determined based on the total number of rows in the image. For example, N may be 5%, 10%, 20%, 50%, or 100% of the rows in the image. In some embodiments, N may be dynamically determined, for example, based on certain results of previous processing of high dynamic range images that were processed to reduce ghosting and motion blur. In some aspects, the means for uniformly sampling the rows may comprise a processor.

At block 215, the method may use an edge detection technique (or process) to locate edges in the sampled rows. In some embodiments, the edge detection technique is an implementation of multi-scale difference of Gaussian (DoG) edge detection. The difference in Gaussian process may be performed on uniformly selected rows, or non-uniformly selected rows. can be performed the uniformly sampled rows. In some examples, a difference of Gaussians technique operates by performing two different Gaussian blurs on an image, with a different blurring radius for each, and subtracting them to yield the result. For example, for each of the sampled rows, the method may include convolving a sampled row with a first Gaussian kernel and a second Gaussian kernel, the second kernel having a standard deviation smaller than the standard deviation of the first Gaussian kernel. For example, the second Gaussian kernel will have a standard deviation smaller than the standard deviation of the first Gaussian kernel. The convolution results may be subtracted and the results are indicative of edges in the row. In implementations where the image includes a row sample, this process may be referred to as a one-dimensional Differences of Gaussian. Another example a difference of Gaussians technique includes subtracting two Gaussians, one having a greater standard deviation than the other, to form a resulting Gaussian, and then convolving an image (or in this case a sampled row) with the resulting image, the results being indicative of edges. In some examples, the radius sizes of the two Gaussians are reversed and in situations where you have a light object on a dark background, reversing them may actually improve results.

In some embodiments, a one-dimensional difference of Gaussian edge detection process may be performed on the selected N rows taken at multiple scales. For example, at multiple image resolution scales for a selected row, for each selected row. Processing a selected row of the image at different scales may result in differing results for the edge detection. FIG. 2B is an illustration 250 of a one dimensional difference-of-Gaussians at multiple scales. For example, this DoG was performed on the same line, with a scale of 2, a scale of 3, and a scale of 4. In some embodiment, the means for calculating the DoG may include a processor.

At block 220, the method determines a blur metric using the difference of Gaussian results for a selected row based on each of the image scales. For example, some embodiments, the metric for the image under consideration may be obtained by calculating an average of the scales of the detected edges. The average may be a weighted average, with weights based on a measure of motion in the neighborhood. For example, if there is more motion in a particular portion of the image, the portion of the image may be given a higher weight. In some embodiments, the difference of Gaussian results of a certain scale may be weighted heavier than the difference of Gaussian results of a another scale. For example, in some embodiments the difference of Gaussian results of a sampled row at a large scale may be weighted heavier than the difference of Gaussian results of the same sampled row at a lower scale. This may be done because the larger scale is expected to include more detail and information, and the lower scale sampled row has already been averaged to some extent to downscale it. In some embodiments, certain selected rows can be given more weight

At block 225, once a metric is obtained based on averaging the difference of Gaussian for each row at each of the scales, this metric may be compared to a threshold to classify the region as either sharp or blurry. Blurry images tend to have a higher metric value (in a system that is using a higher metric value to indicate a blurry image or blurry edge), since edges are smeared and thus wider. Accordingly, by comparing the metric to a threshold, it may be determined whether the image, or a given portion of the image, is blurry or sharp. This threshold may be determined empirically, such as by comparing the weighted averages of each of the images. For example, each of the averages may be compared for all images in a given image set, and the threshold may be determined based on this comparison. For example, the threshold may be determined to only include the sharpest 5%, 10%, 20%, 50%, 80%, 90%, or 95% of images or portions of images. In some aspects, the means for averaging the scale of the edges may include a processor.

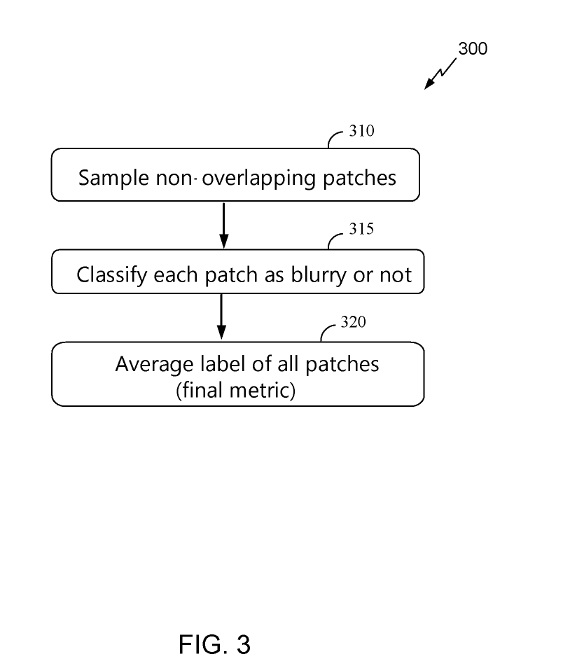

In addition to row-based motion blur detection, motion blur may also be detected using patch-based motion blur detection. FIG. 3 is an illustration 300 of a method for patch-based motion blur detection. This method may be done on an imaging device, such as a cell phone or other wireless device which includes an image sensor. This method may be used in conjunction with other methods, as a part of forming an HDR image as discussed above.

At block 310, the method includes sampling non-overlapping patches from a particular image. In some aspects, a particular number of patches from each image may be chosen. For example, this number may be predefined, or may be based, at least in part, on the size of the image. In some aspects, these patches may cover only a portion of the image, such as 5%, 10%, 20%, 50%, 80% or 90% of the image. In some aspects, the patches may include the entire image, broken up into a particular number of patches. For example, the patches may each comprise patches of a particular size, such as 2×2, 3×3, 4×4, 10×10 pixels or another size (and need not be square), which cover the entire image, or which sample portions of the image. In some aspects, the means for sampling the non-overlapping patches may include a processor.

At block 315, the method classifies each of the patches as blurry or not blurry. For example, multiple patches in each image may be extracted from the given image, and a trained classifier may be used to determine whether each patch is blurred or sharp. In this process the homogenous regions of an image might be ignored. Any patch for which the average of the absolute value of the image derivative is less than a threshold is considered as homogenous. For example, a given patch may include only one color, or colors which are relatively homogenous with each other. Accordingly, the classifier may know that this region is homogenous, or relatively homogenous, and therefore may not include this portion of the image when determining if a patch is blurry or not. This may be useful as in an area with uniform color, it may not be possible to tell whether the subject is blurred or merely uniformly colored. In some aspects, the means for classifying each patch as either blurry or not may be an image classifier, such as a processor.

At block 320, the method may average the label of all the patches to form a final metric. For example, the final metric may be the percentage of non-homogenous patches which were classified as being blurry. For example, the trained classifier may classify each non-homogenous patch in a binary manner, as either blurry or not blurry. The method 300 may use these classifications to determine the percentage of non-homogenous patches which were classified as blurry and/or the percentage of non-homogenous patches which were classified as not blurry. This metric may be compared to a threshold to classify the image as sharp or blurred. For example, this threshold value may be determined empirically. For example, this threshold may be determined based, at least in part, on the metric as calculated for each of a number of networks.

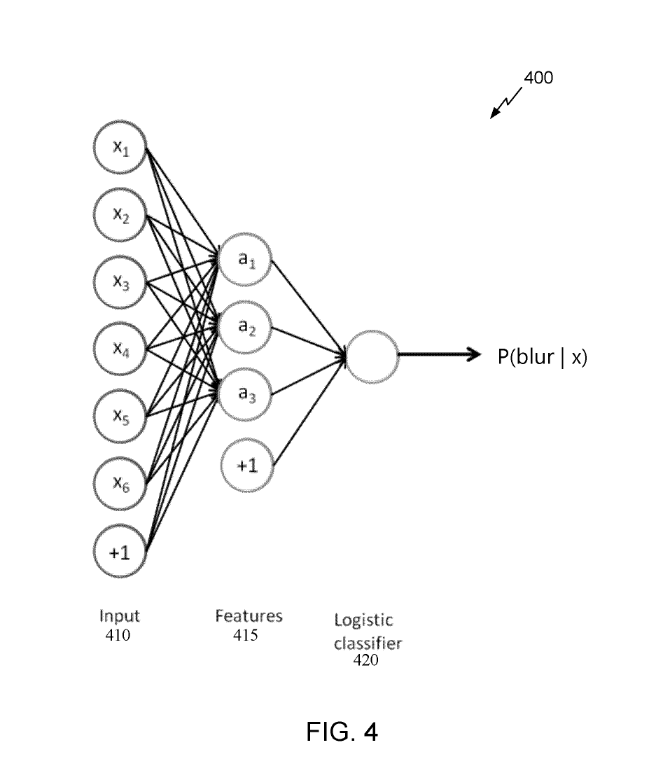

In some aspect, the patch classifier which classifies each of the patches as either blurry or sharp may be implemented as a multi-layer neural network. FIG. 4 is a schematic that illustrates an example of a multi-layer neural network 400 which may be used to determine whether a patch is blurry or sharp. In some aspects, this neural network may have two parts: a feature extractor and a classifier. The feature extractor may learn parameters independently from the classifier. The learned parameters from the classifier may then be substituted in the neural network. The classifier used may be any binary classifier, such as a support vector machine (SVM) classifier, another neural network, or a logistic regression classifier. The classifier may learn the features given to it by the feature extractor. In same aspects, the classifier and the feature extractor may learn parameters together, although this may be more complicated. In some aspects, logistic regression may be used, as it may be simpler than some of the other approaches that may be used for the classifier. Both the feature extractor and the classifier may then be put in place such that, at run time, the features are extracted and then fed to the classifier in order for it to output a binary output.

The multi-layer neural network 400 is an example of one type of classifier that can be used, but this disclosure is not intended to limit such classification to a neural network classifier. The multi-layer neural network may include a first layer, middle layers, and an output layer. For example, the first layer, illustrated here as an input layer 410, of the multi-layer neural network may be the vectorized input patch, such as a patch of the image which was sampled in block 310. The output of the multi-layer neural network may be a binary classifier, which classifies the patch as either sharp or blurry. This classifier is labeled at a logistic classifier 420 in illustration 400. Any binary classifier can be used in place of Logistic Regression. The hidden layers of the multi-layer neural network may include feature extractors 415. In one implementation, the patch classifier may use logistic regression, wherein there is a hidden layer whose features were learned previously using an auto-encoder. For example, logistic regression may be based on Equation 1, below:

P(y=1|x)=σ(w^{T}x) EQN. 1

This formula is based on the logistic sigmoid function, which is given by Equation 2, below:

$$σ ( a ) = \frac{1}{1 + {e}^{- a}} \qquad EQN . 2$$

In the above formulas, P(y=1|x) is the conditional probability of y having a value of 1 when the value of x is known. Here, x is the feature vector received from the feature extractor for the input patch and y is a Boolean variable denoting whether or not the given patch is blurred. P(y=1|x) is given by EQN. 1, where w represents the parameters of logistic regression that are learned during training processing. Accordingly, P(y=1|x) is the logistic sigmoid function (EQN 2) applied to the inner product of x and w. In EQN. 2, e refers to the base of natural logarithm.

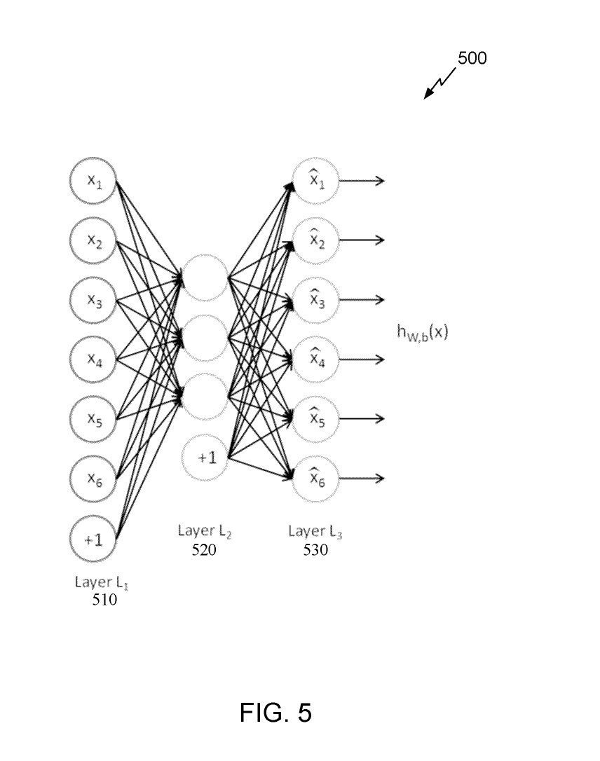

FIG. 5 is an illustration 500 of an unsupervised-feature learning auto-encoder used for patch-based region classification system. This system may include an auto-encoder, which may learn parameters of the network so that the output is as close to the input as possible. For example, an auto-encoder is an example of an unsupervised feature learning algorithm. In such an auto-encoder Layer L₁ 510 denotes a vectorized input patch, as above. The objective of the auto-encoder may be to learn a representation of the patch (as obtained in Layer L₂ 520) such that the patch can be recovered with minimal loss. Layer L₃ 530 is the patch, as estimated from the representation of the patch from Later L₂. Once a representation of sufficient quality has been learned, the first two layers in FIG. 5, Layer L₁ 510 and L₂ 520 may be used as a feature extractor, such as the feature extractor 415 as in FIG. 4.

In some implementations, the above methods may be used to classify either an entire image, or a portion of an image as either blurry or sharp. For both the above methods to determine the blurriness of a region or an image, the regions to classify may be extracted using motion masks generated by the Ghostbuster HDR method, as described above. For example, these regions may be the regions that are most susceptible to motion blur. Accordingly, by using the Ghostbuster HDR method in combination with the above methods for detecting blurriness in either an image or a portion of an image, sharper HDR images may be created. For example, in some aspects, the Ghostbuster HDR method may use a long-exposure image as a reference image, in order to avoid ghosting in the final HDR image. For example, the position of certain portions of the reference image may be compared to the position of the same portions of the short-exposure images, to determine if those objects moved between the images. This may be used to prevent ghosting. However, if the long-exposure image contains motion-blurred objects, ghosting may result if these motion-blurred portions are used as a reference image. Accordingly, it may be very useful to determine whether or not the long-exposure image contains motion-blurred portions when using such an HDR method. In case a region of the long-exposure image is classified as motion blurred, that region may not be used as reference image for ghost removal in Ghostbuster HDR. In some aspects, both of the above methods of local blur detection may give higher accuracy if the input images are resized to a canonical size (for example, 1280 pixels by 960 pixels). For example, the parameters of the blur detection methods may be tuned to a particular size of input. These parameters may also be adapted in accordance with the input image size.

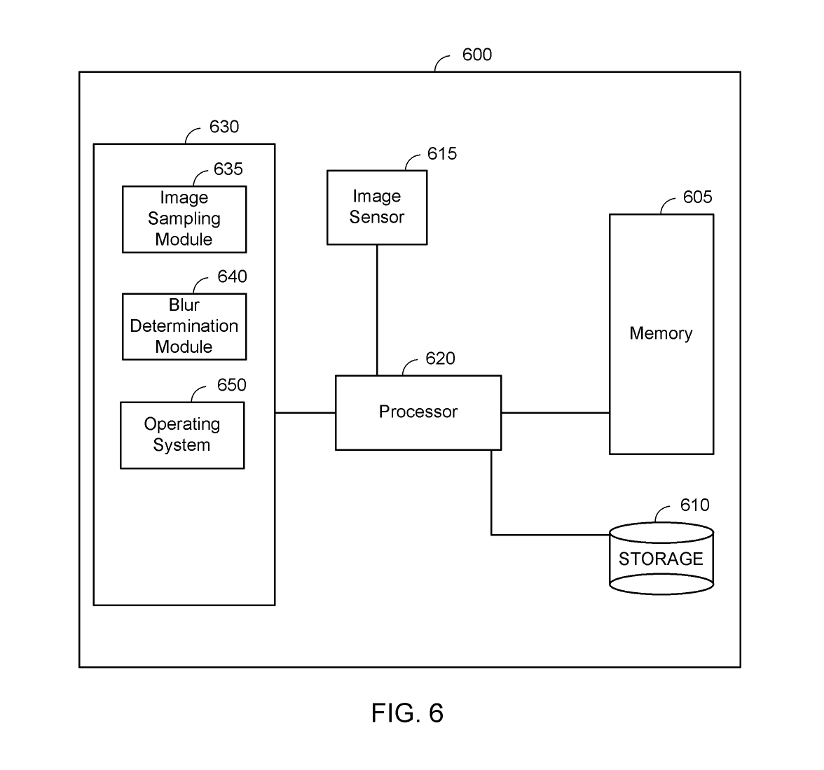

FIG. 6 depicts a high-level block diagram of a device 600 having a set of components including a processor 620 operatively coupled to an image sensor 615. A working memory 605, storage 610, and memory 630 are also in communication with and operative attached to the processor. Device 600 may be a device configured to take digital photographs and/or videos, such as a digital camera, a cell phone, or another device.

The image sensor 615 may be configured to capture a number of pixels of an image. Any number of such pixels may be included on the device 600. The pixels on an image sensor may be arranged in a number of rows and columns, in order to form a grid. The image sensor 615 can be, for example, a charge-coupled device (CCD), a complementary metal-oxide semiconductor (CMOS) sensor, or the like. The image sensor 615 may be coupled to the processor (or “image processor”) 620 to transmit a captured image to the processor 620. The processor 620 may be configured to perform various operations on a received captured image in order to create an output image. In some aspects, the image sensor 615 may be configured to capture a number of different images, with different exposure lengths, as part of creating an HDR image.

Processor 620 may be a general purpose processing unit or a processor specially designed for the disclosed methods. As shown, the processor 620 is connected to a memory 630 and a working memory 605. In the illustrated embodiment, the memory 630 stores image sampling module 635, blur determination module 640 and operating system 650. These modules include instructions that configure the processor to perform various tasks. Working memory 605 may be used by processor 620 to store a working set of processor instructions contained in the modules of memory 630. Alternatively, working memory 605 may also be used by processor 620 to store dynamic data created during the operation of device 600.

As mentioned above, the processor 620 is configured by several modules stored in the memories. For example, the image sampling module 635 may include instructions that configure the processor 620 to sample portions of an image. For example, the image sampling module 635 may sample certain rows from an image. In some aspects, the image sampling module may contain instructions sufficient to allow a processor 620 to sample a number of non-overlapping patches of an image. In some aspects, the image to be sampled from may be received from the image sensor 615, or may be stored in the memory 605 or the storage 610.

The memory 630 may also contain a blur determination module 640. The blur determination module 640 may contain instructions that configure the processor 620 to determine the blurriness of a sampled patch or row of an image. For example, the blur determination module 640 may receive a number of samples patches or rows from the image sampling module 635. For each of these patches or rows, the blur determination module 640 may determine whether the given sample is blurry or not blurry. In some aspects, the images or samples or images used by the blur determination module 640 may be stored in the memory 605 or the storage 610.

Operating system module 650 configures the processor to manage the memory and processing resources of device 600. For example, operating system module 650 may include device drivers to manage hardware resources such as the image sensor 615 or storage 610. Therefore, in some embodiments, instructions contained in modules discussed above may not interact with these hardware resources directly, but instead interact through standard subroutines or APIs located in operating system component 650. Instructions within operating system 650 may then interact directly with these hardware components.

Processor 620 may write data to storage module 610. While storage module 610 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

FIG. 6 depicts a device having separate components to include a processor, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 6 shows two memory components, to include memory component 630 having several modules, and a separate memory 605 having a working memory, one with skill in the art would recognize several embodiments utilizing different memory architectures. For example, a design may utilize ROM or static RAM memory for the storage of processor instructions implementing the modules contained in memory 630. Alternatively, processor instructions may be read at system startup from a disk storage device that is integrated into device 600 or connected via an external device port. The processor instructions may then be loaded into RAM to facilitate execution by the processor. For example, working memory 605 may be a RAM memory, with instructions loaded into working memory 605 before execution by the processor 620.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with the figures may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of determining whether the blurriness of an image renders it unsuitable for constructing a high-dynamic range image, the method comprising:
sampling two or more rows of the image;
detecting edges in each selected row using difference of Gaussians for each row at two of more scales;
calculating an average blurriness value for an image, the average blurriness value based on an average of the blurriness value for each of the sampled rows; and
comparing the average blurriness value to a threshold value to determine if the blurriness of an image renders it unusable to use to construct a high-dynamic range image.

2. The method of claim 1, wherein uniformly sampling two or more rows of the image comprises uniformly sampling each of the rows of the image.

3. The method of claim 1, wherein uniformly sampling two or more rows of the image comprises sampling every Nth row of the image, where N is an integer larger than one.

4. The method of claim 1, wherein uniformly sampling two or more rows of the image comprises sampling N rows of the images, wherein the N rows are approximately evenly spaced out throughout the image.

5. The method of claim 1, wherein the average blurriness value for an image is based on a weighted average of the average of the blurriness values for each of the sampled rows.

6. The method of claim 1, further comprising comparing the average blurriness value for the image to a threshold blurriness value.

7. The method of claim 6, wherein the threshold blurriness value is based, at least in part, on a plurality of average blurriness values for a plurality of different images.

8. The method of claim 6, further comprising determining whether to keep or discard the image, based at least in part on the comparison to the threshold blurriness value.

9. A device configured to determine the blurriness of an image using row-based sampling, the device comprising:
a processor configured to:
uniformly sample two or more rows of the image;
calculate a blurriness value for each of the sampled rows using a multi-scale Difference of Gaussian edge detection; and
calculate an average blurriness value for an image, the average blurriness value based on an average of the blurriness values for each of the sampled rows.

10. The device of claim 9, the processor further configured to compare the average blurriness value for the image to a threshold blurriness value.

11. The device of claim 10, wherein the threshold blurriness value is based, at least in part, on a plurality of average blurriness values for a plurality of different images.

12. The device of claim 10, the processor further configured to determine whether to keep or discard the image, based at least in part on the comparison to the threshold blurriness value.

13. A method of determining the blurriness of an image using patch-based sampling, the method comprising:
sampling two or more non-overlapping patches of the image;
for each of the two or more non-overlapping patches, classifying each patch as either blurry or not blurry; and
calculating a final blurriness value for the image, the final blurriness value based upon a calculation of the proportion of the patches which are either blurry or not blurry.

14. The method of claim 13, where each of the two or more non-overlapping patches of the image are a same size.

15. The method of claim 13, where classifying each patch as either blurry or not blurry comprises using a trained classifier to classify each patch.

16. The method of claim 13, wherein the final blurriness value is further based upon ignoring homogenous patches of the image.

17. The method of claim 16, wherein ignoring the homogenous patches comprises determining if a patch is homogenous based at least in part on a comparison between an average of an absolute value of an image derivative for the patch and a homogeneity threshold.

18. The method of claim 13, further comprising comparing the average blurriness value for the image to a threshold blurriness value.

19. The method of claim 18, wherein the threshold blurriness value is based, at least in part, on a plurality of average blurriness values for a plurality of different images.

20. The method of claim 18, further comprising determining whether to keep or discard the image, based at least in part on the comparison to the threshold blurriness value.
